(19) United States
(12) Patent Application Publication
(10) Pub. No.: US 2006/0250329 A1
(43) Pub. Date: Nov. 9, 2006

(54) Plasma display apparatus

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/429,214

(22) Filed: May 8, 2006

(30) Foreign Application Priority Data
May 9, 2005 (KR) 10-2005-0038575

(51) Int. Cl. G09G 3/28

(52) U.S. Cl. 345/60

(57) ABSTRACT

A plasma display apparatus is provided. A plasma display apparatus comprises a plasma display panel comprising an electrode, a driver for driving the electrode, a control board for controlling the driver, and a noise reduction unit formed on a transmission line of a voltage signal supplied from the control board to the driver, for reducing noise of the voltage signal. Another plasma display apparatus comprises a plasma display panel comprising an electrode, a driver for driving the electrode, a control board for controlling the driver, and a capacitor formed on a transmission line of a voltage signal supplied from the control board to the driver. Still another plasma display apparatus comprises a plasma display panel comprising an electrode, a driver for driving the electrode, a control board for controlling the driver, and a claming diode formed on a transmission line of a voltage signal supplied from the control board to the driver.

This nonprovisional application claims priority under 35 U.S.C. §119(a) on Patent Application No. 10-2005-0038575 filed in Republic of Korea on May 9, 2005, the entire contents of which are hereby incorporated by reference.

### BACKGROUND OF THE INVENTION

1. Field of the Invention

This document relates to a display apparatus, and more particularly, to a plasma display apparatus.

2. Description of the Background Art

In general, a plasma display apparatus in a display apparatus comprises a plasma display panel and a driver for driving the plasma display panel.

In general, a plasma display apparatus comprises a plasma display panel (PDP) in which a barrier rib formed between an upper surface substrate and a lower surface substrate forms a unit cell. A main discharge gas such as Ne, He, and Ne+He and an inert gas containing a small amount of xenon are filled in each cell.

When discharge is generated by a high frequency voltage, the inert gas generates vacuum ultraviolet (UV) rays and emits light from a phosphor formed between the barrier ribs to realize an image. Since the plasma display apparatus can be made thin and light, the plasma display apparatus is spotlighted as a next generation display apparatus.

FIG. 1 illustrates the structure of a common PDP.

As illustrated in FIG. 1, according to the PDP, an upper surface panel 100 obtained by arranging a plurality of pairs of electrodes formed of scan electrodes 102 and sustain electrodes 103 that make pairs on an upper surface glass 101 that is a display surface on which images are displayed and a lower surface panel 110 obtained by arranging a plurality of address electrodes 113 on a lower surface glass 111 that forms the back surface so as to intersect the plurality of pairs of sustain electrodes are combined with each other to run parallel to each other by a uniform distance.

The upper surface panel 100 comprises the scan electrodes 102 and the sustain electrodes 103 for discharging each other in one discharge cell to sustain emission of the cell, that is, the scan electrodes 102 and the sustain electrodes 103 that comprise transparent electrodes a formed of transparent indium tin oxide (ITO) and bus electrodes b formed of metal and that make pairs.

The scan electrodes 102 and the sustain electrodes 103 are covered with one or more dielectric layers 104 for restricting the discharge current of the scan electrodes 102 and the sustain electrodes 103 to insulate the pairs of electrodes from each other. A protective layer 105 on which MgO is deposited is formed on the entire surface of the dielectric layer 104 in order to facilitate discharge.

Stripe type (or well type) barrier ribs 112 for forming a plurality of discharge spaces, that is, discharge cells are arranged on the lower surface panel 110 to run parallel to each other. Also, the plurality of address electrodes 113 that perform address discharge to generate the vacuum UV rays are arranged to run parallel with respect to the barrier ribs 112.

The lower surface panel 110 is coated with the R, G, and B phosphors 114 that emit visible rays to display images during the address discharge. A lower dielectric layer 115 for protecting the address electrodes 113 is formed between the address electrodes 113 and the phosphors 114.

In the PDP having the above structure, a plurality of discharge cells are formed in a matrix.

The discharge cells are formed in the points where the scan electrodes or the sustain electrodes intersect the address electrodes. The arrangement of the electrodes for arranging the plurality of discharge cells in a matrix will be described with reference to FIG. 2.

FIG. 2 illustrates the structure in which the electrodes are arranged in the common PDP.

As illustrated in FIG. 2, in the common plasma display panel 200, the scan electrodes Y1 to Yn and the sustain electrodes Z1 to Zn are arranged to run parallel to each other and the address electrodes X1 to Xm are formed to intersect the scan electrodes Y1 to Yn and the sustain electrodes Z1 to Zn.

Predetermined driving circuits for applying predetermined driving signals are connected to the electrodes of the PDP 200 having the above arrangement structure.

Therefore, the driving signals are applied to the electrodes of the PDP 200 by the above-described driving circuits to implement an image.

The driving circuits are connected to the PDP 200 to form a plasma display apparatus. The structure of the plasma display apparatus will be described with reference to FIG. 3.

FIG. 3 illustrates the structure of a conventional plasma display apparatus in which the conventional PDP is connected to the driving circuits.

Referring to FIG. 3, a PDP 300 is coupled with data drivers 301a, 301b, 301c, 301d, 302a, 302b, 302c, and 302d, a scan driver 303, a sustain driver 304, and a control board 305 to form the conventional plasma display apparatus

The data drivers 301a, 301b, 301c, 301d, 302a, 302b, 302c, and 302d supply data pulses to the address electrodes X₁ to Xₘ of the PDP.

The scan driver 303 drives the scan electrodes Y₁ to Yₙ of the PDP. The sustain driver 304 drives the sustain electrodes Z of the PDP.

The control board 305 supplies sub field mapped data to the data drivers 301a, 301b, 301c, 301d, 302a, 302b, 302c, and 302d and supplies predetermined control signals for controlling the data drivers 301a, 301b, 301c, 301d, 302a, 302b, 302c, and 302d, the scan driver 303, and the sustain driver 304 to the drivers (the data drivers, the scan driver, and the sustain driver), respectively.

For example, as illustrated in FIG. 3, the control board 305 supplies the sub field mapped data to the data driver denoted by reference numeral 301a through a data transmission line denoted by reference numeral 306a and supplies the sub field mapped data to the data driver denoted by reference numeral 301b through a data transmission line denoted by reference numeral 306b.

In the conventional plasma display apparatus having the above-described structure, when predetermined control signals for controlling the data pulses are supplied from the control board 305 to the drivers (the data drivers, the scan driver, and the sustain driver), noise is commonly generated in the predetermined control signals.

The noise generated in the conventional plasma display apparatus during the transmission of the predetermined control signals for controlling the data pulses will be described with reference to FIG. 4.

FIG. 4 illustrates the noise generated in the conventional plasma display apparatus during the transmission of the predetermined control signals for controlling the data pulses.

Referring to FIG. 4, relatively large noise is generated in the conventional plasma display apparatus between the control board 305 and the drivers (the data drivers, the scan driver, and the sustain driver) during the transmission of the predetermined control signals for controlling the data pulses.

For example, as illustrated in FIG. 4, when the predetermined control signals for controlling the data pulses are transmitted from the control board 305 to the data drivers 301a, 301b, 301c, 301d, 302a, 302b, 302c, and 302d, the more distant from the above-described control board 305, the smaller the generated noise is on a signal transmission line.

For example, in the case where a logic signal of a data pulse of 5V is transmitted from the control board 305 to the data drivers 301a, 301b, 301c, 301d, 302a, 302b, 302c, and 302d as illustrated in FIG. 4A, when it is assumed that the amplitude of the logic signal is Ws in a logic signal transmission start step as illustrated in FIG. 4B, noise is generated in the logic signal in a logic signal transmission completion step so that the amplitude of the logic signal is maximized, that is, Wf that is larger than Ws.

The noise of the logic signal is generated by resonance caused by parasitic inductance of a signal transmission line to increase according as the length of the signal transmission line increases.

When excessively large noise is generated in the logic signal so that the magnitude of Wf rapidly increases, the drive integrated circuit (IC) of the data drivers 301a, 301b, 301c, 301d, 302a, 302b, 302c, and 302d is electrically damaged.

In other words, when the noise larger than the rated voltage of the drive IC of the data drivers 301a, 301b, 301c, 301d, 302a, 302b, 302c, and 302d is generated in the logic signal, the drive IC of the data drivers 301a, 301b, 301c, 301d, 302a, 302b, 302c, and 302d is electrically damaged.

As described above, the noise of the logic signal is generated by the parasitic inductance of the signal transmission line to vary with the length of the signal transmission line.

The maximum magnitude of the generated noise may vary with the drivers. Therefore, since the drivers must be composed of elements having different voltage withstand properties, that is, different rated voltages, manufacturing processes become complicated and manufacturing cost increases.

The above will be described in detail with reference to FIG. 5.

FIG. 5 illustrates that the magnitude of noise varies with the length of the signal transmission line in the conventional plasma display apparatus.

Referring to FIG. 5, since the length of a signal transmission line 306a for transmitting the logic signal of the data pulse from the control board 305 to the data driver denoted by the reference numeral 301a is different from the length of a signal transmission line 306b for transmitting the logic signal from the control board 305 to the data driver denoted by the reference numeral 301b in FIG. 3, the magnitude of the parasitic inductance of the signal transmission line 306a is different from the magnitude of the parasitic inductance of the signal transmission line 306b.

Therefore, the magnitude of the noise generated in the logic signal transmitted to the data driver denoted by the reference numeral 301a through the signal transmission line denoted by reference numeral 306a is different from the magnitude of the noise generated in the data pulse transmitted to the data driver denoted by the reference numeral 301b through the signal transmission line denoted by reference numeral 306b.

For example, when it is assumed that noise is generated in the logic signal whose amplitude is Ws₁ in the signal transmission start step so that the maximum amplitude of the logic signal becomes Wf₁ during the transmission of the data pulse to the data driver denoted by the reference numeral 301a through the signal transmission line denoted by the reference numeral 306a as illustrated in FIG. 5A, noise is generated in the logic signal whose amplitude is Ws₂ in the signal transmission start step so that the maximum amplitude of the logic signal becomes Wf₂ that is smaller than the Wf₁ during the transmission of the logic signal to the data driver denoted by the reference numeral 301b through the signal transmission line denoted by the reference numeral 306b that is shorter than the signal transmission line denoted by the reference numeral 306a.

Therefore, the voltage withstand property of the data driver denoted by the reference numeral 301a must be larger than the voltage withstand property of the data driver denoted by the reference numeral 301b.

Therefore, when the data driver denoted by the reference numeral 301b is composed of elements having the voltage withstand property that can withstand the Wf₁, manufacturing cost unnecessarily increases. When the data driver denoted by the reference numeral 301a and the data driver denoted by the reference numeral 301b are composed of elements having different voltage withstand properties, the manufacturing processes of the plasma display apparatus become complicated so that the manufacturing cost increases.

The case in which the logic signal of the data pulse is supplied to the data drivers is taken as an example. However, the above problems are also generated when the predetermined control signal for controlling the data drivers, the scan driver, and the sustain driver is transmitted from the control board.

### SUMMARY OF THE INVENTION

Accordingly, an object of the present invention is to solve at least the problems and disadvantages of the background art.

It is an object of the present invention to provide a plasma display apparatus that is capable of preventing drivers from being electrically damaged.

A plasma display apparatus according to an embodiment of the present invention comprises a plasma display panel comprising an electrode, a driver for driving the electrode, a control board for controlling the driver, and a noise reduction unit formed on a transmission line of a voltage signal supplied from the control board to the driver, for reducing noise of the voltage signal.

A plasma display apparatus according to another embodiment of the present invention comprises a plasma display panel comprising an electrode, a driver for driving the electrode, a control board for controlling the driver, and a capacitor formed on a transmission line of a voltage signal supplied from the control board to the driver.

A plasma display apparatus according to still another embodiment of the present invention comprises a plasma display panel comprising an electrode, a driver for driving the electrode, a control board for controlling the driver, and a claming diode formed on a transmission line of a voltage signal supplied from the control board to the driver.

According to the present invention, the noise reduction unit is formed on the transmission line of the voltage signal supplied from the control board to the driver so that it is possible to reduce the noise generated in the voltage signal and to thus protect driving circuits.

### BRIEF DESCRIPTION OF THE DRAWINGS

The present invention will be described in detail with reference to the following drawings in which like numerals refer to like elements.

FIG. 1 illustrates the structure of a common plasma display panel (PDP).

FIG. 2 illustrates the structure in which electrodes are arranged in the common PDP.

FIG. 3 illustrates the structure of a conventional plasma display apparatus in which a conventional PDP is connected to driving circuits.

FIG. 4 illustrates noise generated in the conventional plasma display apparatus during the transmission of data pulses or predetermined control signals.

FIG. 5 illustrates that the magnitude of the generated noise varies with the length of a signal transmission line in the conventional plasma display apparatus.

FIG. 6 illustrates the structure of a plasma display apparatus according to an embodiment of the present invention.

FIG. 7 illustrates the operations of noise reduction units in the plasma display apparatus according to an embodiment of the present invention.

FIG. 8 illustrates a method of reducing the generated noise whose magnitude varies with the length of the signal transmission line in the plasma display apparatus according to an embodiment of the present invention.

FIG. 9 illustrates the sum of the capacitances of the noise reduction units in accordance with the length of the voltage signal transmission line in the plasma display apparatus according to an embodiment of the present invention.

FIG. 10 illustrates an example in which the noise reduction units are composed of clamping diodes in a plasma display apparatus according to another embodiment of the present invention.

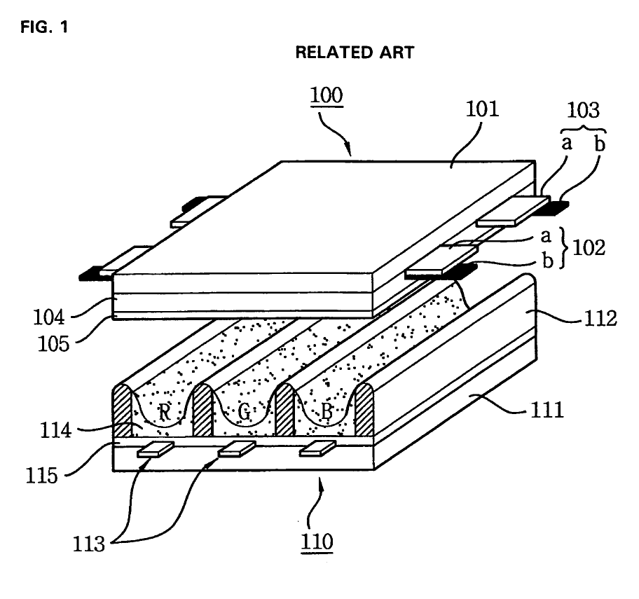

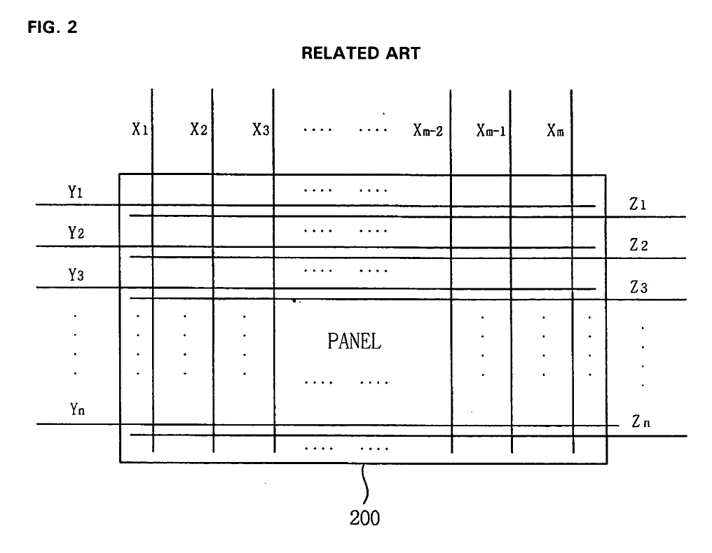

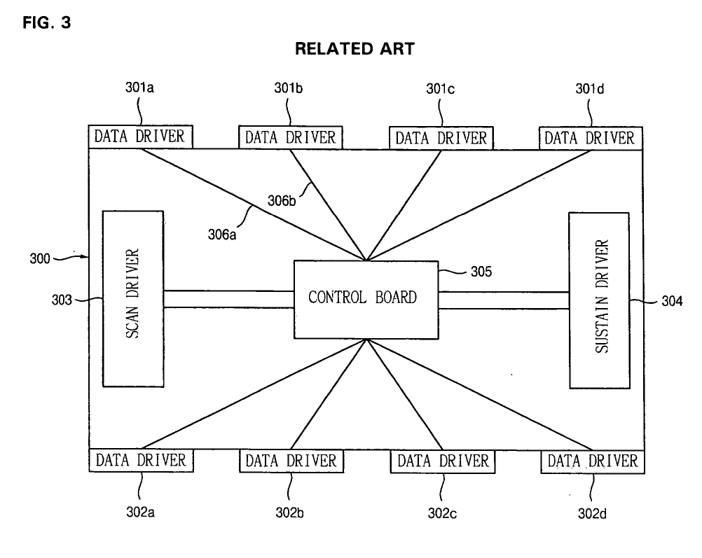

### DETAILED DESCRIPTION OF PREFERRED EMBODIMENTS

Preferred embodiments of the present invention will be described in a more detailed manner with reference to the drawings.

A plasma display apparatus according to an embodiment of the present invention comprises a plasma display panel comprising an electrode, a driver for driving the electrode, a control board for controlling the driver, and a noise reduction unit formed on a transmission line of a voltage signal supplied from the control board to the driver, for reducing noise of the voltage signal.

The number of the noise reduction units is preferably two or more.

The voltage signal is preferably a control signal for controlling the driver.

The control signal is preferably a signal for controlling a data signal supplied to the electrode.

A plasma display apparatus according to another embodiment of the present invention comprises a plasma display panel comprising an electrode, a driver for driving the electrode, a control board for controlling the driver, and a capacitor formed on a transmission line of a voltage signal supplied from the control board to the driver.

The number of the capacitors is preferably two or more.

The voltage signal is preferably a control signal for controlling the driver.

The control signal is preferably a signal for controlling a data signal supplied to the electrode.

The capacitance of the capacitors preferably ranges from 10 pF to 100 nF.

The capacitors are preferably disposed between the transmission line of the voltage signal and the ground (GND).

The capacitors preferably comprise a first capacitor and a second capacitor and a capacitance of the first capacitor and a capacitance of the second capacitor, on the transmission line of the voltage signal, are preferably equal to each other.

The capacitors preferably comprise a first capacitor and a second capacitor and a capacitance of the first capacitor and a capacitance of the second capacitor, on the transmission line of the voltage signal, are preferably different from each other.

A length from the driver to the first capacitor is preferably more than a length from the driver to the second capacitor and the capacitance of the first capacitor is preferably less than the capacitance of the second capacitor.

The number of the transmission lines is preferably two or more.

The transmission line of the voltage signal preferably comprises a first voltage signal transmission line and a second voltage signal transmission line and the sum of the capacitance of each of the capacitors located on the first voltage signal transmission line is preferably different from the sum of the capacitance of each of the capacitors located on the second voltage signal transmission line.

A length of the first voltage signal transmission line is preferably more than a length of the second voltage signal transmission line and the sum of the capacitance of each of the capacitors located on the first voltage signal transmission line is preferably more than the sum of the capacitance of each of the capacitors located on the second voltage signal transmission line.

A plasma display apparatus according to still another embodiment of the present invention comprises a plasma display panel comprising an electrode, a driver for driving the electrode, a control board for controlling the driver, and a claming diode formed on a transmission line of a voltage signal supplied from the control board to the driver.

The number of the claming diodes is preferably two or more.

The voltage signal is preferably a control signal for controlling the driver.

The control signal is preferably a signal for controlling a data signal supplied to the electrode.

The clamping diode preferably filters noise components using a reference voltage supplied from a reference voltage source.

The clamping diode comprises a first clamping diode disposed between the transmission line of the voltage signal and a first reference voltage source and a second clamping diode disposed between the transmission line of the voltage signal and a second reference voltage source.

The first clamping diode preferably has a cathode terminal connected to the transmission line of the voltage signal and an anode terminal connected to the first reference voltage source and the second clamping diode preferably has a cathode terminal connected to the second reference voltage source and an anode terminal connected to the transmission line of the voltage signal.

The first reference voltage source preferably supplies a reference voltage of a ground level (GND) and the second reference voltage source preferably supplies a reference voltage of substantially 5V.

Hereinafter, an embodiment of the present invention will be described with reference to the attached drawings.

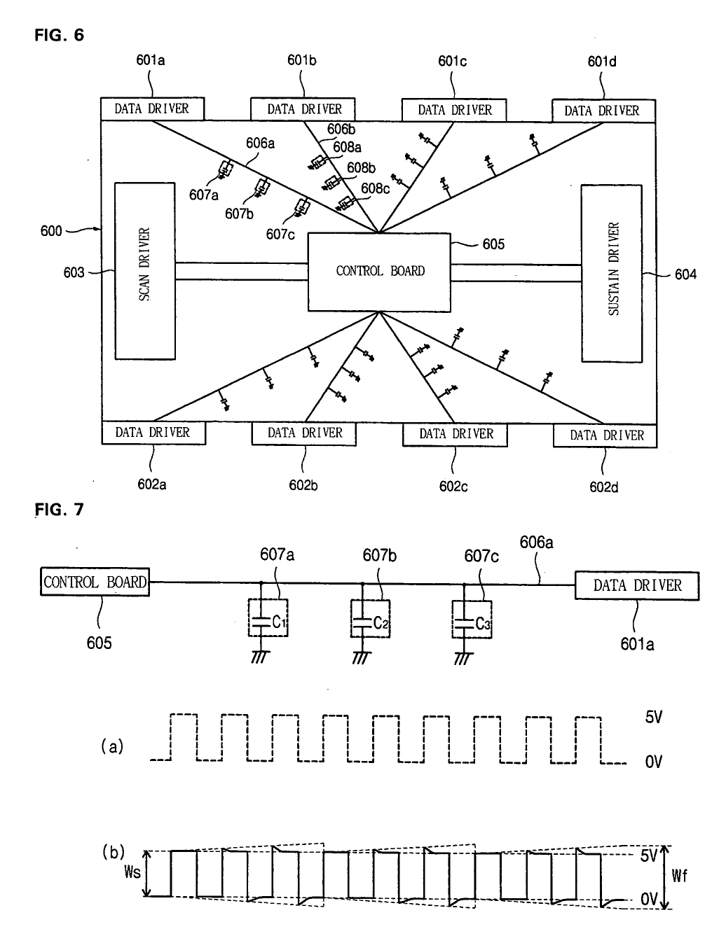

FIG. 6 illustrates the structure of a plasma display apparatus according to an embodiment of the present invention.

As illustrated in FIG. 6, in the plasma display apparatus according to an embodiment of the present invention, a PDP 600 is coupled with data drivers 601a, 601b, 601c, 601d, 602a, 602b, 602c, and 602d, a scan driver 603, a sustain driver 604, and a control board 605 and noise reduction units 607a, 607b, 607c, 608a, 608b, and 608c are provided on transmission lines of voltage signals supplied from the control board 605 to the drivers (the data drivers, the scan driver, and the sustain driver).

In the above-described PDP 600, an upper surface panel (not shown) and a lower surface panel (not shown) are attached to each other by a uniform distance, a plurality of electrodes, for example, scan electrodes Y₁ to Yₙ and sustain electrodes Z are formed to make pairs, and address electrodes X₁ to Xₘ are formed to intersect the scan electrodes Y₁ to Yₙ and the sustain electrodes Z.

Data that are reverse gamma corrected and error diffused by a reverse gamma correcting circuit and an error diffusing circuit that are not shown and that are mapped to each sub field by a sub field mapping circuit are supplied to the data drivers 601a, 601b, 601c, 601d, 602a, 602b, 602c, and 602d.

The data drivers 601a, 601b, 601c, 601d, 602a, 602b, 602c, and 602d sample and latch data in response to data timing control signals CTRX from the control board 605 to supply the data to the address electrodes X₁ to Xₘ.

The scan driver 603 supplies a rising ramp waveform Ramp-up and a falling ramp waveform Ramp-down to the scan electrodes Y₁ to Yₙ in a reset period under the control of the control board 605.

Also, the scan driver 603 sequentially supplies a scan pulse Sp of a scan voltage −Vy to the scan electrodes Y₁ to Yₙ in an address period under the control of the control board 605 and supplies a sustain pulse SUS to the scan electrodes Y₁ to Yₙ in a sustain period.

The sustain driver 604 supplies a predetermined positive bias voltage to the sustain electrodes Z in the period where the falling ramp waveform Ramp-down is generated and in the address period under the control of the control board 605 and alternates with the scan driver 603 in the sustain period to supply the sustain pulse SUS to the sustain electrodes Z.

The control board 605 supplies the sub field mapped data to the data drivers 601a, 601b, 601c, 601d, 602a, 602b, 602c, and 602d and supplies predetermined control signals for controlling the data drivers 601a, 601b, 601c, 601d, 602a, 602b, 602c, and 602d, the scan driver 603, and the sustain driver 604 to the drivers (the data drivers, the scan driver, and the sustain driver).

For example, as illustrated in FIG. 6, the control board 605 supplies the sub field mapped data to the data driver denoted by reference numeral 601a through a data transmission line denoted by reference numeral 606a and supplies the sub field mapped data to the data driver denoted by reference numeral 601b through the data transmission line denoted by reference numeral 606b.

The noise reduction units 607a, 607b, 607c, 608a, 608b, and 608c are provided on the transmission lines of the voltage signals supplied from the control board 605 to the drivers (the data drivers, the scan driver, and the sustain driver) as described above to reduce the noise generated in the voltage signals.

For example, as illustrated in FIG. 6, the noise reduction units 607a, 607b, 607c, 608a, 608b, and 608c are provided on the transmission lines 606a and 606b of the voltage signals supplied from the control board 605 to the data drivers 601 a, 601b, 601c, 601d, 602a, 602b, 602c, and 602d, for example, the sub field mapped data pulses to reduce the noise generated in the sub field mapped data pulses.

In FIG. 6, the noise reduction units 607a, 607b, 607c, 608a, 608b, and 608c are provided only on the transmission lines of the sub field mapped data pulses. However, the noise reduction units 607a, 607b, 607c, 608a, 608b, and 608c may be provided on the transmission line of a voltage signal different from the above-described sub field mapped data pulses.

For example, although not shown, the control board 605 supplies a control signal through a predetermined signal transmission line in order to control the scan driver 603 or the sustain driver 604. The control signal is a voltage signal like the above-described sub field mapped data pulses. Therefore, the noise reduction units 607a, 607b, 607c, 608a, 608b, and 608c may be provided on the signal transmission line through which the above-described control signal is supplied.

In the plasma display apparatus according to an embodiment of the present having the above-described structure, a plurality of noise reduction units are preferably formed on the transmission line of one voltage signal.

The operations of the noise reduction units in the plasma display apparatus according to an embodiment of the present invention will be described with reference to FIG. 7.

FIG. 7 illustrates the operations of the noise reduction units in the plasma display apparatus according to an embodiment of the present invention.

Referring to FIG. 7, the noise reduction units 607a, 607b, and 607c provided on the transmission line of the sub field mapped data pulse supplied from the control board 605 to the data driver denoted by the reference numeral 601a among the noise reduction units of the plasma display apparatus according to an embodiment of the present invention of FIG. 6 will be taken as an example to describe the operations of the noise reduction units of the plasma display apparatus according to the present invention.

When the sub field mapped data pulse that is the voltage signal illustrated in FIG. 7A is supplied from the control board 605 to the data driver denoted by the reference numeral 601 a, noise is generated in the above-described sub field mapped data pulse due to resonance caused by the parasitic inductance of the transmission line of the sub field mapped data pulse denoted by the reference numeral 606a. The noise reduction units 607a, 607b, and 607c are provided on the transmission line of the sub field mapped data pulse denoted by the reference numeral 606a so that the magnitude of the noise generated in the data pulse is reduced as illustrated in FIG. 7B in the positions on the transmission line denoted by the reference numeral 606a where the noise reduction units 607a, 607b, and 607c are provided.

Each of the noise reduction units 607a, 607b, and 607c preferably comprises a capacitor positioned between the transmission line of the voltage signal and a ground GND.

As described above, each of the noise reduction units 607a, 607b, and 607b comprises a capacitor having capacitance of predetermined magnitude to remove the high frequency noise component generated in the sub field mapped data pulse.

For example, when it is assumed that the sub field mapped data pulse that starts from the control board 605 has amplitude of Ws as illustrated in FIG. 7B, the sub field mapped data pulse is transmitted to the data driver denoted by the reference numeral 601a through the signal transmission line denoted by the reference numeral 606a so that noise is generated by the parasitic inductance.

First, the high frequency noise component generated in the above-described sub field mapped data pulse is removed by the noise reduction unit denoted by reference numeral 607a.

The sub field mapped data pulse from which the high frequency noise component is first removed by the capacitor of the noise reduction unit denoted by the reference numeral 607a continuously proceeds on the signal transmission line denoted by the reference numeral 606a so that noise is generated again by the parasitic inductance.

The generated noise is removed by the capacitor of the noise reduction unit denoted by reference numeral 607b.

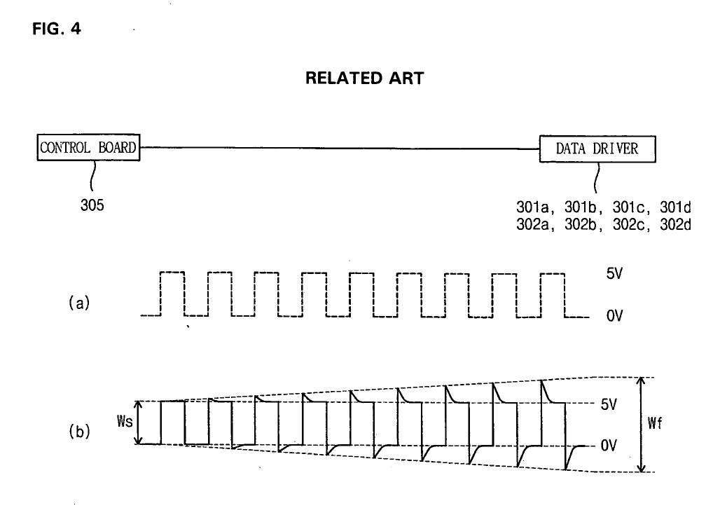

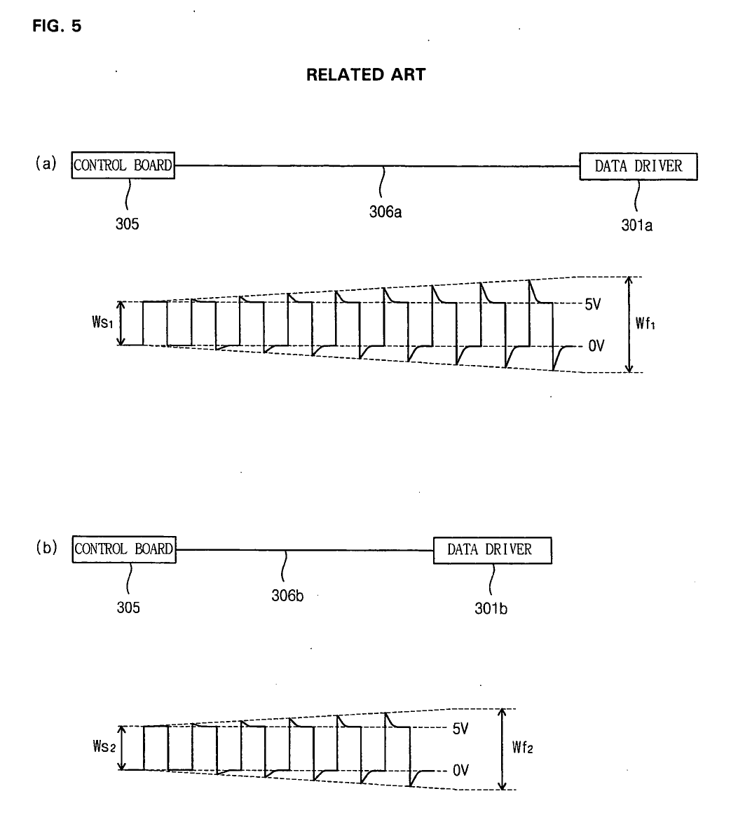

Noise that is generated again is removed by the capacitor of the noise reduction unit denoted by reference numeral 607c. Therefore, the maximum amplitude Wf of the sub field mapped data pulse supplied from the control board 605 to the data driver denoted by the reference numeral 601a is smaller than that of FIG. 4.

Therefore, although the rated voltage of the data driver denoted by the reference numeral 601a is smaller than that of the conventional art, the drive integrated circuit (IC) of the data driver denoted by the reference numeral 601a is not electrically damaged.

As a result, the data drivers can be composed of elements having a relatively lower voltage withstand property than that of the conventional art so that it is possible to reduce the manufacturing cost of the data drivers.

The capacitances of the capacitors on the same voltage signal transmission line are preferably equal to each other in the noise reduction units of FIG. 6.

For example, the capacitances of the capacitors of the noise reduction unit denoted by the reference numeral 607a, the noise reduction unit denoted by the reference numeral 607b, and the noise reduction unit denoted by the reference numeral 607c that are provided on the sub field mapped data pulse transmission line denoted by the reference numeral 606a are equal to each other.

As described above, when the capacitances of the capacitors of the noise reduction units are equal to each other, it is possible to easily manufacture the noise reduction units.

Unlike the above, the capacitance of the capacitor of one or more noise reduction unit may be different from the capacitance of the capacitor of another noise reduction unit.

For example, the capacitance of the capacitor of the noise reduction unit denoted by the reference numeral 607a is different from the capacitance of the capacitor of another noise reduction unit, that is, the noise reduction unit denoted by the reference numeral 607b or 607c on the transmission line of the sub field mapped data pulse denoted by the reference numeral 606a.

The capacitance of the capacitor of the noise reduction unit denoted by the reference numeral 607a is preferably larger than the capacitance of the capacitor of the noise reduction unit denoted by the reference numeral 607b or 607c.

In other words, the capacitance of the capacitor of a first noise reduction unit that is close to the driver is preferably smaller than the capacitance of the capacitor of a second noise reduction unit that is more distant from the driver than the first noise reduction unit on the same voltage signal transmission line.

The capacitor of each of the noise reduction units preferably ranges from 10 pF to 100 nF. That is, the capacitance is controlled in the range of 100 pF to 100 nF.

When the capacitance of each of the noise reduction unit is set to be no less than 10 pF, it is possible to sufficiently remove the noise generated in the data pulses. The reason why the capacitance is set to be no more than 100 nF is to prevent the area occupied by the noise reduction units having the capacitance from excessively increasing and to prevent manufacturing cost from increasing. Therefore, the capacitance of each of the noise reduction units is controlled to range from 10 pF to 100 nF.

The distance between two continuous noise reduction units is preferably equal to the distance between another two continuous noise reduction units on the same voltage signal transmission line.

For example, the distance between the noise reduction unit denoted by the reference numeral 607a and the noise reduction unit denoted by the reference numeral 607b is preferably equal to the distance between the noise reduction unit denoted by the reference numeral 607b and the noise reduction unit denoted by the reference numeral 607c. The reason why the distance between two continuous noise reduction units is equal to the distance between another two continuous noise reduction units it to prevent the generation of the noise using a limited number of noise reduction units.

A plurality of noise reduction units are provided on the transmission line of one voltage signal, for example, the transmission line of one sub field mapped data pulse in the above.

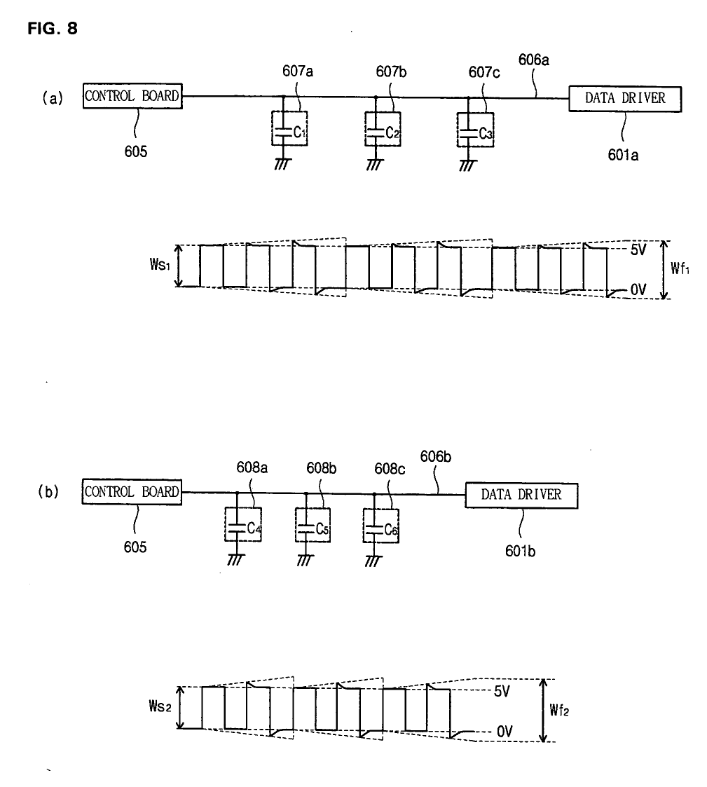

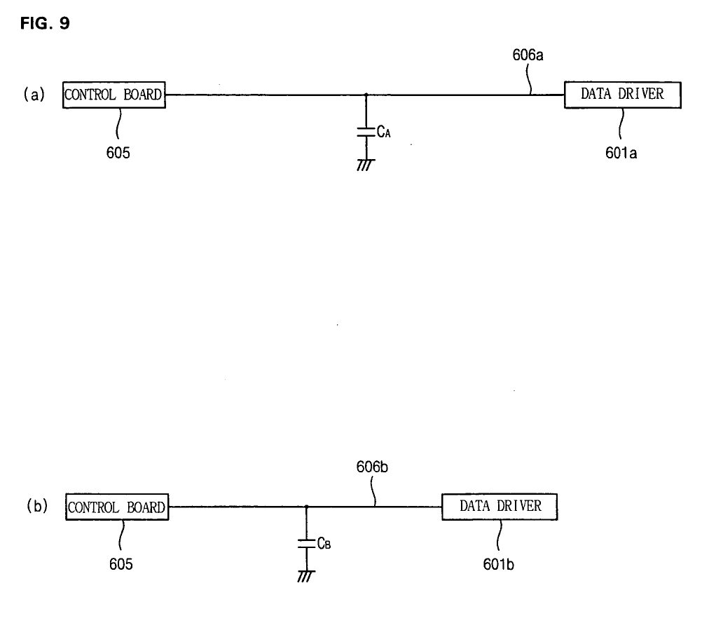

However, the number or capacitances of the noise reduction units may be controlled in accordance with the length of the transmission line of the voltage signal, which will be described with reference to FIGS. 8 and 9.

FIG. 8 illustrates a method of reducing the generated noise whose magnitude varies with the length of the signal transmission line in the plasma display apparatus according to an embodiment of the present invention.

FIG. 9 illustrates the sum of the capacitances of the noise reduction units in accordance with the length of the voltage signal transmission line in the plasma display apparatus according to an embodiment of the present invention.

First, referring to FIG. 8, since the length of the signal transmission line 606a for transmitting the sub field mapped data pulse from the control board 605 to the data driver denoted by the reference numeral 601a is different from the length of the signal transmission line 606b for transmitting the sub field mapped data pulse from the control board 605 to the data driver denoted by the reference numeral 601b, the magnitude of the parasitic inductance of the signal transmission line 606a is different from the magnitude of the parasitic inductance of the signal transmission line 606b.

Therefore, the magnitude of the noise generated in the sub field mapped data pulse transmitted to the data driver denoted by the reference numeral 601a through the signal transmission line denoted by the reference numeral 606a is different from the magnitude of the noise generated in the sub field mapped data pulse transmitted to the data driver denoted by the reference numeral 601b through the signal transmission line denoted by the reference numeral 606a. In order to reduce the noise whose magnitude varies, the noise reduction units having different capacitances are provided on the transmission lines of the voltage signals having different lengths.

That is, the sum of the capacitances of the capacitors of the noise reduction units positioned on one voltage signal transmission line is preferably different from the sum of the capacitances of the capacitors of the noise reduction units positioned on another voltage signal transmission line.

For example, when the sub field mapped data pulse is transmitted to the data driver denoted by the reference numeral 601a through the signal transmission line denoted by the reference numeral 606a as illustrated in FIG. 8A, it is assumed that the sum of the capacitances of the capacitors of the noise reduction units denoted by the reference numerals 607a, 607b, and 607c provided on the signal transmission line denoted by the reference numeral 606a is C_{A}.

In the case where the sub field mapped data pulse is transmitted to the data driver denoted by the reference numeral 601b through the signal transmission line denoted by the reference numeral 606b that is shorter than the signal transmission line denoted by the reference numeral 606a as illustrated in FIG. 8B, when it is assumed that the sum of the capacitances of the capacitors of the noise reduction units denoted by the reference numerals 608a, 608b, and 608c provided on the signal transmission line denoted by the reference numeral 606b is C_{B} as illustrated in FIG. 9, the C_{A} is preferably larger than C_{B}.

In other words, the sum of the capacitances of the capacitors of the noise reduction units positioned on a first voltage signal transmission line is preferably smaller than the sum of the capacitances of the capacitors of the noise reduction units positioned on a second voltage signal transmission line that is longer than the first voltage signal transmission line.

It is assumed that noise is generated in the sub field mapped data pulse whose amplitude is Ws₁ in a signal transmission start step and the noise is reduced by the noise reduction units denoted by the reference numerals 607a, 607b, and 607c so that the maximum amplitude of the sub field mapped data pulse becomes Wf₁ during the transmission of the sub field mapped data pulse to the data driver denoted by the reference numeral 601a through the signal transmission line denoted by the reference numeral 606a as illustrated in FIG. 8A.

When it is assumed that noise is generated in the sub field mapped data pulse whose amplitude is Ws₂ in the signal transmission start step and the noise is reduced by the noise reduction units denoted by the reference numerals 608a, 608b, and 608c so that the maximum amplitude of the sub field mapped data pulse becomes Wf₂ during the transmission of the sub field mapped data pulse to the data driver denoted by the reference numeral 601b through the signal transmission line denoted by the reference numeral 606b that is shorter than the signal transmission line denoted by the reference numeral 606a, Wf₁ is preferably equal to Wf₂.

A difference in the magnitude of the noise that is caused by a difference in the parasitic inductance in accordance with a difference in length between the signal transmission lines denoted by the reference numerals 606a and 606b is compensated by C_{A} and C_{B} of FIG. 9 so that Wf₁ becomes equal to Wf₂.

Therefore, it is possible to make the voltage withstand property of the data driver denoted by the reference numeral 601a equal to the voltage withstand property of the data driver denoted by the reference numeral 601b so that it is possible to simplify the manufacturing processes of the plasma display apparatus and to thus reduce the manufacturing cost.

According to the above description, in the plasma display apparatus according to an embodiment of the present invention, the noise reduction units are composed of the capacitors.

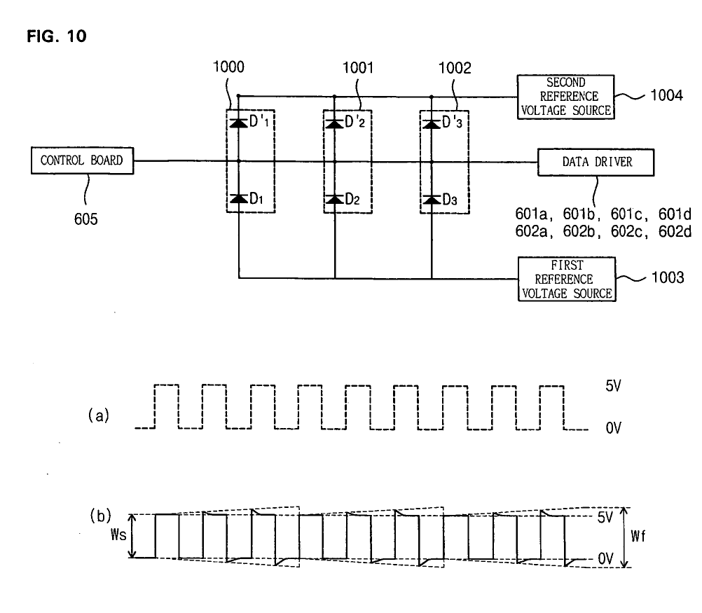

However, unlike the above, the noise reduction units may be composed of clamping diodes, which will be described with reference to FIG. 10.

FIG. 10 illustrates an example in which the noise reduction units are composed of clamping diodes in a plasma display apparatus according to another embodiment of the present invention.

Referring to FIG. 10, unlike in FIGS. 6 to 9, in FIG. 10, noise reduction units 1000, 1001, and 1002 are composed of clamping diodes.

In other words, the noise reduction units 1000, 1001, and 1002 preferably comprise clamping diodes for filtering noise components by reference voltages supplied from first and second reference voltage sources 1003 and 1004.

The noise reduction units 1000, 1001, and 1002 will be described in detail. Each of the noise reduction units 1000, 1001, and 1002 preferably comprises a first clamping diode positioned between the transmission line of the voltage signal and the first reference voltage source 1003 and a second clamping diode positioned between the transmission line of the voltage signal and the second reference voltage source 1004.

For example, as illustrated in FIG. 10, the noise reduction units 1000, 1001, and 1002 comprise the first clamping diodes D1, D2, and D3 and the second clamping diodes D1′, D2′, and D3′, respectively.

The cathode terminals of the first clamping diodes D1, D2, and D3 are connected to the transmission line of the voltage signal, that is, the transmission line for supplying the sub field mapped data pulse from the control board 605 to the data drivers 601a, 601b, 601c, 601d, 602a, 602b, 602c, and 602d and the anode terminals of the first clamping diodes D1, D2, and D3 are connected to the first reference voltage source 1003.

The anode terminals of the second clamping diodes D1′, D2′, and D3′ are connected to the transmission line of the voltage signal and the cathode terminals of the second clamping diodes D1′, D2′, and D3′ are connected to the second reference voltage source 1004.

The first reference voltage source 1003 preferably supplies a reference voltage of a ground level GND and the second reference voltage source 1004 preferably supplies a reference voltage of substantially 5V.

Therefore, when the sub field mapped data pulse illustrated in FIG. 10A is supplied from the control board 605 to the data drivers 601a, 601b, 601c, 601d, 602a, 602b, 602c, and 602d, noise no more than 0V and noise no less than substantially 5V that are generated in the sub field mapped data pulse are removed as illustrated in FIG. 10B.

Like in the noise reduction units composed of the capacitors, in the noise reduction units 10000, 1001, and 1002 composed of the clamping diodes, the distance between two continuous noise reduction units is preferably equal to the distance between another two continuous noise reduction units on the same voltage signal transmission line.

Since the case in which the noise reduction units are composed of the clamping diodes is substantially the same as the case in which the noise reduction units are composed of the capacitors as illustrated in FIGS. 6 to 9, description of the case in which the noise reduction units are composed of the clamping diodes will be omitted.

According to the present invention, the noise reduction units are provided on the transmission lines of the voltage signals supplied from the control board to the drivers so that it is possible to reduce the noise generated in the voltage signals and to thus protect the driving circuits.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus comprising:
a plasma display panel comprising an electrode;
a driver for driving the electrode;
a control board for controlling the driver; and
a noise reduction unit formed on a transmission line of a voltage signal supplied from the control board to the driver, for reducing noise of the voltage signal.

2. The plasma display apparatus as claimed in claim 1, wherein the number of the noise reduction units is two or more.

3. The plasma display apparatus as claimed in claim 2, wherein the voltage signal is a control signal for controlling the driver.

4. The plasma display apparatus as claimed in claim 3, wherein the control signal is a signal for controlling a data signal supplied to the electrode.

5. A plasma display apparatus, comprising:
a plasma display panel comprising an electrode;
a driver for driving the electrode;
a control board for controlling the driver; and
a capacitor formed on a transmission line of a voltage signal supplied from the control board to the driver.

6. The plasma display apparatus as claimed in claim 5, wherein the number of the capacitors is two or more.

7. The plasma display apparatus as claimed in claim 6, wherein the voltage signal is a control signal for controlling the driver.

8. The plasma display apparatus as claimed in claim 7, wherein the control signal is a signal for controlling a data signal supplied to the electrode.

9. The plasma display apparatus as claimed in claim 6, wherein the capacitance of the capacitors ranges from 10 pF to 100 nF.

10. The plasma display apparatus as claimed in claim 6, wherein the capacitors are disposed between the transmission line of the voltage signal and the ground (GND).

11. The plasma display apparatus as claimed in claim 6, wherein the capacitors comprise a first capacitor and a second capacitor, and a capacitance of the first capacitor and a capacitance of the second capacitor, on the transmission line of the voltage signal, are equal to each other.

12. The plasma display apparatus as claimed in claim 6, wherein the capacitors comprise a first capacitor and a second capacitor, and
a capacitance of the first capacitor and a capacitance of the second capacitor, on the transmission line of the voltage signal, are different from each other.

13. The plasma display apparatus as claimed in claim 12, wherein a length from the driver to the first capacitor is more than a length from the driver to the second capacitor, and
the capacitance of the first capacitor is less than the capacitance of the second capacitor.

14. The plasma display apparatus as claimed in claim 5, wherein the number of the transmission lines is two or more.

15. The plasma display apparatus as claimed in claim 14, wherein the transmission line of the voltage signal comprises a first voltage signal transmission line and a second voltage signal transmission line, and
the sum of the capacitance of each of the capacitors located on the first voltage signal transmission line is different from the sum of the capacitance of each of the capacitors located on the second voltage signal transmission line.

16. The plasma display apparatus as claimed in claim 15, wherein a length of the first voltage signal transmission line is more than a length of the second voltage signal transmission line, and
the sum of the capacitance of each of the capacitors located on the first voltage signal transmission line is more than the sum of the capacitance of each of the capacitors located on the second voltage signal transmission line.

17. A plasma display apparatus, comprising:
a plasma display panel comprising an electrode;
a driver for driving the electrode;
a control board for controlling the driver; and
a claming diode formed on a transmission line of a voltage signal supplied from the control board to the driver.

18. The plasma display apparatus as claimed in claim 14, wherein the number of the claming diodes is two or more.

19. The plasma display apparatus as claimed in claim 18, wherein the voltage signal is a control signal for controlling the driver.

20. The plasma display apparatus as claimed in claim 19, wherein the control signal is a signal for controlling a data signal supplied to the electrode.

21. The plasma display apparatus as claimed in claim 18, wherein the clamping diode filters noise components using a reference voltage supplied from a reference voltage source.

22. The plasma display apparatus as claimed in claim 18, wherein the clamping diode comprises:
a first clamping diode disposed between the transmission line of the voltage signal and a first reference voltage source; and
a second clamping diode disposed between the transmission line of the voltage signal and a second reference voltage source.

23. The plasma display apparatus as claimed in claim 22, wherein the first clamping diode has a cathode terminal connected to the transmission line of the voltage signal and an anode terminal connected to the first reference voltage source, and
the second clamping diode has a cathode terminal connected to the second reference voltage source and an anode terminal connected to the transmission line of the voltage signal.

24. The plasma display apparatus as claimed in claim 23, wherein the first reference voltage source supplies a reference voltage of a ground level (GND), and
the second reference voltage source supplies a reference voltage of substantially 5V.
